(19) United States
(12) Patent Application Publication
(10) Pub. No.: US 2005/0097304 A1
(43) Pub. Date: May 5, 2005

(54) Pipeline recirculation for data misprediction in a fast-load data cache

(75) Inventor: David A. Luick, Rochester, MN (US)

Correspondence Address: IBM Corporation;Intellectual Property Law, Dept. 917, 3605 Hwy. 52 North, Rochester, MN, 55901, US

(73) Assignee: INTERNATIONAL BUSINESS MACHINES CORPORATION, ARMONK, NY (US)

(21) Appl. No.: 10/697,503

(22) Filed: Oct. 30, 2003

(51) Int. Cl. G06F 9/44

(52) U.S. Cl. 712/225

(57) ABSTRACT

A system and method in a computer architecture for selectively permitting data, such as instructions, in a pipeline to be executed based upon a speculative data load in a fast-load data cache. Each data load that is dependent upon the load of a specific data load is selectively flagged in a pipeline that selectively loads, executes, and/or flushes each data load, while the fast-load data cache speculatively loads one or more data loads. Upon the determination of a misprediction of a speculative data load, the data loads flagged as dependent on the mispredicted data load are not used in the one or more pipelines, and are alternately flushed.

### BACKGROUND OF THE INVENTION

1. Field of the Invention

The present invention generally relates to computer architecture. More particularly, the invention relates to a device and method for invalidating pipelined data from an errant guess in a speculative fast-load instruction cache.

2. Description of the Related Art

In computer architecture, the usage of extensive transistors on a microprocessor allows for a technology called “pipelining.” In a pipelined architecture, a series of instruction execution overlaps in a series of transistors called the pipeline. Consequently, even though it might take four clock cycles to execute each specific instruction, there can be several instructions in various stages of execution simultaneously within the pipeline to optimally achieve the completion of one instruction for every clock cycle. Many modern processors have multiple instruction decoders, and each decoder can have a dedicated pipeline. Such architecture provides multiple data streams of instructions which can accelerate processor throughput whereby more than one instruction can complete during each clock cycle. However, errors in instructions can require the entire instruction to be flushed from the pipeline, or a non-sequential instruction execution, i.e. one instruction in the pipeline requires 5 clock cycles while another requires 3 clock cycles, causes less than one instruction to be completed per clock cycle.

“Caching” is a technology based on a memory subsystem of the processor whereby a smaller and faster data store, such as a bank of registers or buffers, can fetch, hold, and provide data to the processor at a much faster rate than other memory. For example, a cache that can provide data access at two times faster than the main memory access is called a level 2 cache or an L2 cache. And a smaller and faster memory system that exchanges data directly into the processor, and is accessed at the cyclic rate of the processor, as opposed to the speed of the memory bus, is called a level 1 cache (L1 cache). For example, on a 233-megahertz (MHz) processor, L1 cache is 3.5 times faster than the L2 cache, which is two times faster than the processor access to main memory.

The cache will hold data that is most likely to be needed by the processor for instruction execution. The cache uses a principle called “locality of reference” which assumes that data most frequently accessed or most recently accessed will be the most likely data again needed by the processor and stores that data in the cache(s). Upon instruction execution, the processor first searches the cache(s) for the required data, and if the data is present (a cache “hit”) the data is provided at the faster rate, and if the data is not present (a cache “miss”) the processor will access main memory a slower rate looking for the data, and in the worst case, peripheral memory which is the slowest data transfer rate.

A number of methods have been proposed to initiate load instructions for sequential execution in a speculative manner such that a correct guess made as to the instruction sequence will speed the data throughput and execution. To that end, a special fast load (L0) data cache has been used to access a cache element that is likely, but not certain, to be the correct one for instruction execution, and that cache element is likely to have dependent data loads/instructions. A correct speculative guess can produce a load target 1 to 3 cycles earlier that an L1 cache. However, the use of such a fast-load data cache within a superscalar pipelined computer architecture with a significant queue of pipelined instructions can be problematic due the likelihood of an errant instruction load that will require the pipeline to flush the instruction stream. Depending upon the size of the pipeline, the recovery time to restart the instruction causing an event can be as significant as 5-10 clock cycles. In the worst case, a speculative L0 data cache that has a high miss rate can actually hinder overall processor performance.

Additionally, the L0 data cache has to maintain coherency for all data accesses, which is difficult when used with a data bus that have several potential callers of the L0Cache. In such instance, the L0 data cache must check every potential accessing device's directory to make sure that the devices have access to the common data load at any given point.

Although, all of the instructions held within the pipeline may not be adversely affected from an incorrect guess at the L0 data cache. In such case, otherwise correct instructions are flushed from the pipeline. For example, if half of the load instructions in a 5 cycle pipeline can make use of speculative instruction loading but the speculative fast access is wrong 20-40%, which is typical for extant L0 caches, the total penalty cycles can equal the speculative gain in cycles so that no or only a very small net performance gain is possible. Therefore, it would be advantageous to provide a system that can give the benefit of correct speculative instruction loading in a fast-load L0 cache, but not incur significant penalties from flushing otherwise correct instructions from the pipeline. Accordingly, the present invention is primarily directed to such a system and method for recirculating pipeline data upon a misprediction in the fast-load data cache.

### SUMMARY OF THE INVENTION

The present invention is a system and method in a computer architecture for selectively permitting some pipelined instructions to be executed or items of data processed while other pipelined instructions or data that are based upon a misprediction of an instruction or data speculatively loaded in a fast-load data cache are not executed. Each instruction or data load that is dependent upon the load of a specific instruction or data load is selectively flagged in a pipeline that can selectively load, execute, and/or flushes each instruction or item of data, while the fast-load data cache speculatively executes a load cache fetch access. Upon the determination of a misprediction of a speculatively loaded instruction, the data loads flagged as dependent on that specific instruction or data are not executed in the one or more pipelines, which avoids the necessity of flushing the entire pipeline.

The system for selectively permitting instructions in a pipeline to be executed based upon a misprediction of a speculative instruction loaded in a fast-load data cache includes one or more pipelines, with each pipeline able to selectively start, execute, and flush each instruction, and each instruction is selectively flagged to indicate dependence upon the load of a specific instruction. The system also includes at least one fast-load data cache that speculatively executes one or more load instructions or data, and upon the determination of the misprediction of a load instruction, the instructions flagged as dependent on that specific instruction are not executed in the one or more pipelines. The speculative instruction can be loaded in the one or more pipelines, or can be loaded in a separate data store with one or more of the instructions in the pipeline(s) dependent thereupon. The flag can be a bit within the instruction, or data attached to the instruction. In one embodiment, the flagged dependent specific instruction can be flushed from the one or more pipelines upon the determination of the misprediction of a loaded instruction.

In one embodiment, the system generates speculative versions of the instructions or data loads, which can be invalid because the speculative data load that initiated that sequence accessed incorrect data because of a wrong “guess” access, and the speculative (and faster) load and following instruction sequence is invalidated. The nonspeculative instruction, which is always correct is marked valid and always completes execution. Thus, on a speculative “bad guess” case of a load, no time is actually lost because the nonspeculative sequence executes on time, assuming sufficient resources are always available. Overall performance of the system can be modified to have only one speculative instruction load allowed per cycle and two load/store and four ALU (FX) execution units available, which ensures that adequate resources are present to handle the otherwise valid nonspeculative instruction.

The method for selectively permitting instructions in a pipeline to be executed based upon a misprediction of a speculative instruction or data loaded in a fast-load data cache includes the steps of loading data into a pipeline, selectively flagging one or more of the instructions or data to indicate dependence upon the load of a specific instruction, speculatively loading a speculative instruction in a fast-load data cache, determining if the speculative instruction is a misprediction, and then selectively executing the instructions not flagged as dependent on that specific instruction determined to be a misprediction.

The present system and method accordingly provide an advantage in that a processor can gain a multicycle advantage from correct speculative instruction loading in a fast-load data cache (L0), but not incur significant penalties from having to flush otherwise correct instructions from the pipeline. The system is simple in implementation as it uses flag bits, either within the instruction or attached to the instruction, to indicate the instructions based upon speculative instruction loads, which does not significantly add to complexity of processor design or consumption of space on the chip.

Other objects, advantages, and features of the present invention will become apparent after review of the hereinafter set forth Brief Description of the Drawings, Detailed Description of the Invention, and the Claims.

### BRIEF DESCRIPTION OF THE DRAWINGS

FIG. 1 is a prior art block diagram of a pipelined series of instructions that incurs a 5-cycle penalty upon a miss in the fast-load data cache (L0 Dcache).

FIG. 2 is a block diagram illustrating a prior art implementation of a fast-load data cache.

FIG. 3 is a block diagram illustrating the load cache physical layout, and specifically showing the fast-load data cache laid out at the same rank as the ALU.

FIG. 4 is a block diagram of a speculative and nonspeculative issue instances of a dependent instruction R.

FIG. 5 is a block diagram of the temporarily valid and speculative bits appended to each pipeline instruction after a load.

FIG. 6 is a representative diagram of a pipelined cycle of instructions utilizing the fast-load data cache (L0 Dir) to set and reset speculative bits on the pipelined instructions.

FIG. 7 is a block diagram of a generalized N-issue superscalar pipeline with instruction reissue.

### DETAILED DESCRIPTION OF THE INVENTION

With reference to the figures in which like numerals represent like elements throughout, FIG. 1 illustrates a prior art pipelined series of instructions that incurs a 5-cycle penalty upon a miss in a fast-load data cache (L0 Dcache 12). The five cycles include the IC cycle (L1 Instruction cache access), the RI (Register File access) cycle, the ALU (Arithmetic Logic Unit) or AGEN (Address Generation) cycle, the DC (Data Cache Access), and the WB (Register File write back) cycle. As used herein, the term “instruction” in conjunction with data items held in a pipeline means any command, operator, transitional product or other data handled in the registers of the pipeline. Here, the pipelined load instructions are reviewed to determine if a misprediction has been made in an instruction load, i.e. if the data load in L0 Dcache 12 was a cache miss. If an incorrect load has occurred, the instruction pipeline is invalidated, rolled back and restarted, and the instruction can be recycled and the event recorded. Thus, a 5-cycle penalty is incurred. The instruction group must then be serialized and again placed into the pipeline from the last valid instruction. The present invention allows the parallel use of instruction/load sequences where one of the sequences is speculative based upon the load in the fast-load data cache L0 Dcache 12.

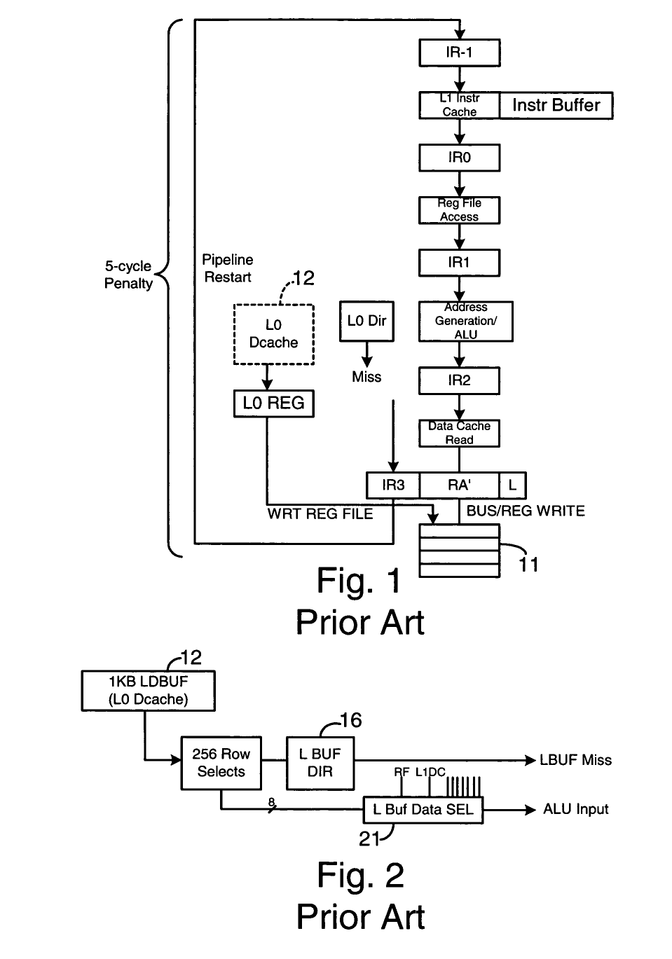

FIG. 2 is a block diagram of a illustrating a prior art implementation of a fast-load data cache 12. A fast-load data cache (L0 Dcache 12) allows all data loads to access the cache, and is implemented as normal, directory-based associative, coherent data cache. Here, LBUF (L0) Directory 16 indicates a miss when the access is not contained in the data cache. Upon a directory hit, the Load-Buffer data select 21 will latch the data from the fast-load data cache (L0 Dcache 12). In order to achieve the very fast one-cycle access time, the size is highly restricted to be no larger than 1 KB. And if all load references use the cache, the miss rate becomes unacceptably high and the reload time for the L0 Dcache 12 completely stalls the pipeline.

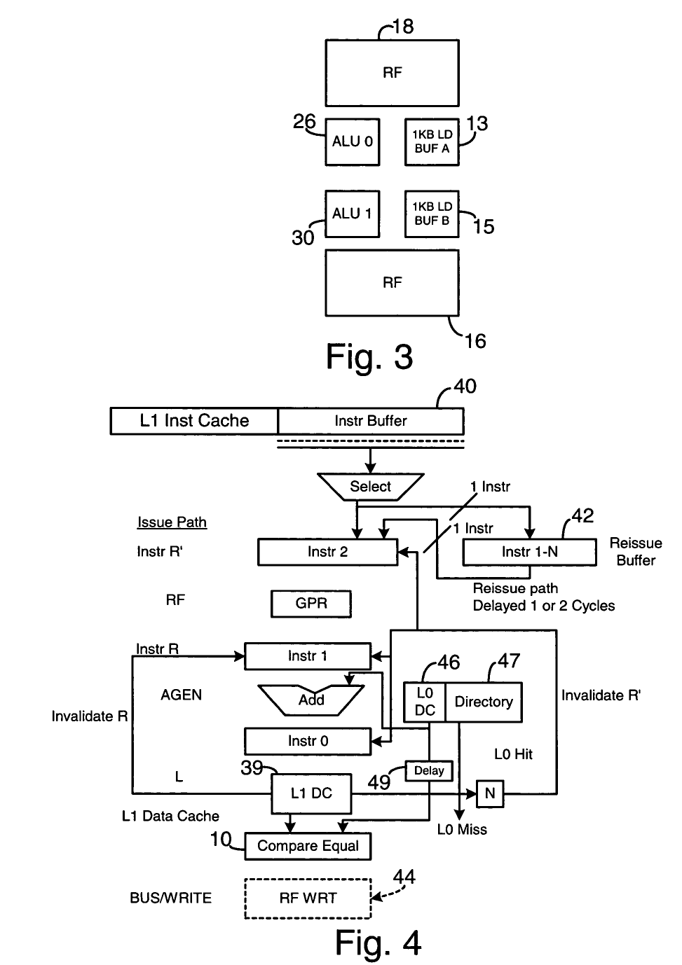

FIG. 3 is a block diagram illustrating the fast-load data cache physical layout on a processor core chip area with the fast-load data caches, sown here as 1 KB LD BUF A 13 and 1KB LD BUF B 15, near the ALUs 26,30 to meet the requirement that the fast-load data caches 13,15 that must access and forward in one cycle just as the ALUs 26,30 do. Special care is taken to select the cache address for the next data cache access so that the most critical address bits to be very close to the AGEN logic to initiate the next cache access (LBUF/L0 or L1) quickly. Register files 16,18 are also in close proximity to the ALUs 26,30 so that the correct data can be latched without cycle penalty upon a correct speculative guess load.

FIG. 4 is a block diagram of a speculative and nonspeculative issue instances of a dependent instruction R. A specially flagged (as temporarily valid) speculative access from an L0 Dcache 46, which typically produces a load target result 1-3 cycles earlier than the L1 cache 39. Dependent instructions after the load can follow. However, in addition, a nonspeculative copy of the load can also be sent down the same pipeline with any dependent instructions in the next few cycles afterward (where the number of cycles equals the difference in latency between the L0 and L1 accesses). If it is determined that the fast speculative load instruction produced correct results, the speculative versions of the instructions are kept along with their results while the nonspeculative but now erroneous versions of the instructions earlier in the pipe are invalidated and thus have no lasting effect.

The example in FIG. 4 shows data initially loaded at instruction buffer 40, and the addition of an instruction reissue buffer 42 contains the nonspeculative instance of the load plus dependent instruction(s) immediately following the fast-load of the speculative instruction which accesses the fast-load data cache 46 (L0 Dcache) and its associated directory 47. In certain cases, the directory 47 can be omitted from the architecture, so long as the L0 Dcache 46 is a one-way associate or direct-map cache. Thus, no set selection function is required of the directory, and because a direct-map embodiment of fast-load data cache (L0 Dcache 46) is a speculative and non-coherent cache the remaining hit or miss functionality of the directory is replaced by the compare equal 10 result.

The instruction (R) is issued first assuming a fast-load data cache (L0 Dcache 46) hit, and then a second time (N cycles) later, both marked temporarily valid where N equals the number of cycles of additional latency incurred in an L1 Dcache 39 access. A compare 10 with the L1 DCache 39 and a delay 49 of the L0 Dcache 46 determines if the speculative load in the L0 Dcache 46 (which was earlier than the load to L1Dcache 39) was correct. As long as the fast-load data cache (L0 Dcache 46) hit/miss indication is known at least one cycle before the register file is written (Register file write 44), the proper copy of the instruction (R or R′) is validated and the other (R′ or R) is invalidated depending on a fast-load data cache (L0 Dcache 46) hit or miss. In other words, both possible outcomes—a fast-load data cache (L0 Dcache 46) hit or L1hit)—have pipelined execution in order with only the fastest valid instruction copy actually completing execution. In such manner, the entire pipeline is not required to be flushed upon an incorrect speculative load, and consequently, a cycle savings occurs, e.g. instead of a 5 cycle penalty as shown in FIG. 1, the worst case is a 4 cycle penalty if a L0 cache 46 miss occurs.

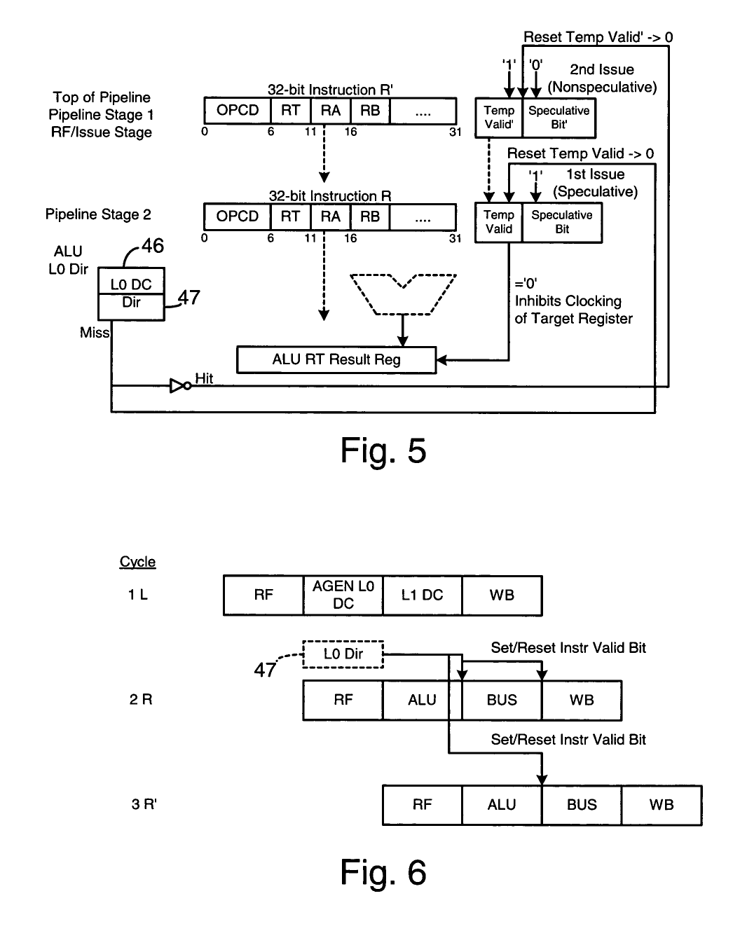

However, no matter how fast the fast-load data cache (L0 Dcache 46) miss signal is made to be during the AGEN cycle of the load, it is never fast enough to allow the pipeline to execute a simple 1-cycle stall to allow the data from the L1 data cache to be used since the fast-load data cache (L0 Dcache 46) has missed. In fact, a 2-cycle stall is difficult. Thus, losing three cycles for every fast-load data cache (L0 Dcache 46) miss at a 25-30% miss eliminates most of the performance gain on hits (one cycle) so as to render it unusable. Conversely, as FIG. 4 shows, there is ample time to invalidate an instruction before its target(s) is (are) written to the register file, i.e. register file write 44. Here, the hit/miss indication from the directory can have up to two cycles delay 49 to reach the register file 44 to inhibit a write. Although, it is more convenient to simply append a valid bit to each instruction and keep it as a flag bit through all stages of execution, as is shown in FIG. 5. Then, only this single valid bit need be reset (to indicate an invalid instruction) and which will prohibit any further cycles from producing results based on the corresponding instruction. Alternately, the pipeline can also flush the invalid instruction if desired. Through the use of the system, it is not only unnecessary to attempt to stall hundreds of latches throughout the pipeline, but only a single latch or subset of latches (valid bit), and further, the remainder of the next cycle is available to actually prevent the now invalid pipe stage result from being latched (kept).

FIG. 5 is a block diagram of the temporarily valid and speculative bits appended to each pipeline instruction after a load. Instances of a typical dependent instruction R is issued speculatively as R′ assuming an L0 Dcache 46 hit, and also issued a second time as R′ assuming an L0 Dcache miss and a L1 Dcache hit. The initial speculative data load is marked with a “speculative” bit and data loads dependent upon a specific speculative load are marked with “temporarily valid” bits to indicate their dependency. Thus, both R and R′ are marked “temporarily valid” until the L0 miss/hit indication, and then the correct sequence is marked valid, the other marked invalid, which ultimately NO-OPs the instructions/data loads by preventing the results from the errant instruction being clocked or used.

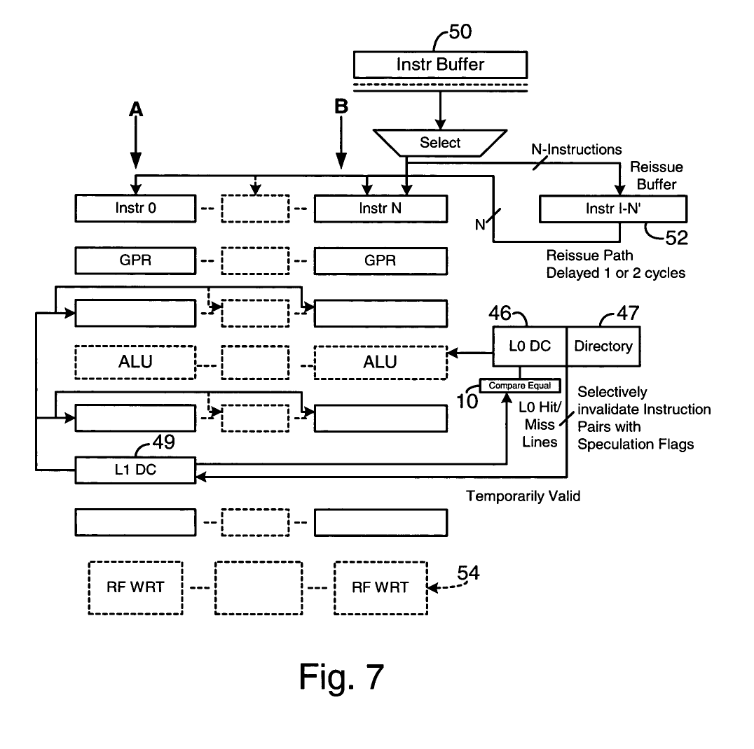

FIG. 6 is a representative diagram of a pipelined cycle of instructions utilizing the fast-load data cache (L0 DCache 46) to set and reset speculative bits on the pipelined instructions. Thus, in cycle 1, the instruction is loaded (L), and in cycle 2 instruction ADD (R) that is dependent on load target is loaded with the Instruction valid bit set or reset at this stage by the Lo Directory 47. Then in cycle 3, the ADD′(R′)—the reissued ADD—is marked as temporarily valid and is invalidated if L0 Dcache 46 hits, and ADD is invalidated if L0 misses with ADD′ validated, i.e. the instruction valid bit is set to valid.

FIG. 7 is a block diagram of a generalized N-issue superscalar pipeline with instruction reissue with two exemplary pipelines A and B. In the pipeline, multiple instructions are issued each cycle and where multiple speculative instructions exist in the pipelines (instructions following the load) along with other nonspeculative instructions. Here, selective invalidation of instructions in pipeline stages must occur, i.e., only instruction pairs marked temporarily valid are affected by fast-load data cache (L0 Dcache 46) miss signals where other instructions started in order without speculation are allowed to proceed normally. Here, the instruction buffer 50 loads the data loads into the pipelines, and reissue buffer 52 is enlarged to four instructions equaling the largest issue group for a four-pipeline superscalar. It should also be noted that the same scheme works to eliminate the stall conditions for value prediction miscompares with the assumption that the miscompare must be known at the end of the L1 Dcache 49 and a compare equal access to invalidate a register file write 54 in time. It should be noted that each pipeline does not need to be speculatively loaded, i.e. pipeline A can include speculatively loaded data capable of flushing whereas pipeline B can include nonspeculative instructions or data that is processed in parallel with pipeline A.

It can thus be seen that the system thus provides a method for selectively permitting instructions in a pipeline, such as the pipelines in FIGS. 4 and 7, to be executed based upon a speculative instruction or data loaded in a fast-load data cache 46, comprising the steps of loading one or more instructions into a pipeline, selectively flagging one or more of the instructions to indicate dependence upon the load of a specific instruction, speculatively loading a speculative data load in a fast-load data cache 46, determining if the speculative data load is a misprediction, such as through compare 10 in FIG. 4, and selectively executing the instructions/data loads not flagged as dependent on that specific instruction determined to be a misprediction, i.e. not temporarily valid. The method can further include the step of loading the speculative instruction into the pipeline, and the step of flushing the flagged dependent specific instruction from the pipeline upon the determination of the misprediction of a loaded instruction

The step of selectively flagging the one or more instructions does not necessarily flag an instruction that is not dependent on any specific instruction. Further, the step of selectively flagging the instruction can occur through altering a bit within the instruction, and alternately, through attaching a flag of one or more bits to the instruction.

While the foregoing disclosure shows illustrative embodiments of the invention, it should be noted that various changes and modifications could be made herein without departing from the scope of the invention as defined by the appended claims. Furthermore, although elements of the invention may be described or claimed in the singular, the plural is contemplated unless limitation to the singular is explicitly stated.

1. In a computer architecture, a system for selectively permitting data loads in a pipeline to be executed based upon a speculative data load in a fast-load data cache, comprising:
one or more pipelines, each pipeline able to selectively load, execute, and flush a series of data loads, and each data load selectively flagged to indicate dependence upon the loading of a specific data load; and
at least one fast-load data cache that loads one or more speculative data loads;
wherein upon determination of a misprediction for a specific speculative data load, the data loads flagged as dependent on that specific speculative data load not being executed in the one or more pipelines.

2. The system of claim 1, wherein the speculative data load is loaded in the one or more pipelines.

3. The system of claim 1, wherein one or more of the data loads in the one or more pipelines are not dependent on any specific data load and not selectively flagged.

4. The system of claim 1, wherein the flag is a bit within the data load.

5. The system of claim 1, wherein the flag is attached to the data load 6. The system of claim 1, wherein the flagged dependent specific data load is flushed from the one or more pipelines upon the determination of a misprediction for a data load.

7. The system of claim 1, wherein the fast-load data cache includes a directory.

8. The system of claim 1, wherein the fast-load data cache does not include a directory.

9. A method for selectively permitting data loads in a pipeline to be executed based upon a speculative data load in a fast-load data cache, comprising the steps of:
loading one or more data loads into a pipeline;
selectively flagging one or more of the data loads to indicate dependence upon the load of a specific data load;
loading a speculative data load in a fast-load data cache;
determining if the speculative data load is a misprediction; and
selectively executing the data loads not flagged as dependent on that specific data load determined to be a misprediction.

10. The method of claim 9, further comprising the step of loading the speculative data load into the pipeline.

11. The method of claim 9, wherein the step of selectively flagging the one or more data loads does not flag any data load that is not dependent on any specific data load.

12. The method of claim 9, wherein the step of selectively flagging the data load occurs through altering a bit within the data load.

13. The method of claim 9, wherein the step of selectively flagging the data load occurs through attaching a flag to the data load.

14. The method of claim 7, further comprising the step of flushing the flagged dependent specific data load from the pipeline upon the determination of a misprediction of a data load.

15. In a computer architecture, a system for selectively permitting instructions in a pipeline to be executed based upon a speculative data load, comprising:
a means for pipelining one or more data loads, the means able to selectively load, execute, and flush each data load;
a means for selectively flagging one or more data loads to indicate dependence upon the load of a specific data load;
a means for speculatively loading one or more data loads; and
a means for determining a misprediction of a speculative data load,
wherein upon the determination of a misprediction in a speculative data load, the means for pipelining not using data loads flagged as dependent on that specific data load.

16. The system of claim 13, wherein the pipeline means flushes the flagged dependent data load upon the determination of a misprediction in a speculative data load.
